(19) United States
(12) Patent Application Publication
(10) Pub. No.: US 2002/0167381 A1
(43) Pub. Date: Nov. 14, 2002

(54) Display panel drive apparatus

(75) Inventors: Shigeo Ide, Nakakoma-gun (JP); Kenichi Kobayashi, Nakakoma-gun (JP)

Correspondence Address: SUGHRUE MION, PLLC, 2100 PENNSYLVANIA AVENUE, N.W., WASHINGTON, DC, 20037, US

(73) Assignee: PIONEER CORPORATION

(21) Appl. No.: 10/135,771

(22) Filed: May 1, 2002

(30) Foreign Application Priority Data
May 8, 2001 (JP) 2001-137207

(51) Int. Cl. G09G 3/28

(52) U.S. Cl. 335/60; 345/204

(57) ABSTRACT

A drive apparatus for driving a display panel having a plurality of row electrode groups each of which includes a plurality of row electrodes, and a plurality of column electrodes arrayed in the direction intersecting with each row electrode of the plurality of row electrode groups to form display cells at the intersection points. The drive apparatus comprises a controller for generating a control signal for each of the row electrode groups, and a row electrode drive circuit for generating a drive pulse in response to the control signal and supplying the pulse to each row electrode of each of the row electrode groups. The control signal is delayed when being supplied to the drive circuit for each of the row electrode groups.

### BACKGROUND OF THE INVENTION

1. Field of the Invention

The present invention relates to a drive apparatus for a display panel such as a matrix display-type plasma display panel (PDP).

2. Description of the Related Background Art

It is well known that a PDP is a thin, flat display for which various kinds of research have been conducted, and that one kind of PDP is known as a matrix display-type PDP.

FIG. 1 shows a schematic configuration of a PDP drive apparatus having the PDP.

As shown in FIG. 1, a PDP 1 has row electrodes Y₁ to Yₙₖ and row electrodes X₁ to Xₙₖ forming row electrode pairs such that each X and Y pair corresponds to each row (row 1 to row nk) of a single screen. The PDP 1 additionally comprises column electrodes D₁ to Dₘ constituting column electrodes that correspond to each column (column 1 to column m) of a single screen. The column electrodes D₁ to Dₘ are formed orthogonally to the row electrode pairs with dielectric layers and a discharge gap, which are not shown in the figure, interposed therebetween. A discharge cell that corresponds to a single pixel is formed at the intersection of one row electrode pair and one column electrode.

The row electrodes X₁ to Xₙₖ and row electrodes Y₁ to Yₙₖ are each divided into n groups of k rows per group. Specifically, these groups are X₁ to X_{k,} Xₖ₊₁ to X₂ₖ, . . . , X₍ₙ₋₁₎ₖ₊₁ to Xₙₖ and Y₁ to Yₖ, Yₖ₊₁ to Y₂ₖ, . . . , Y₍ₙ₋₁₎ₖ₊₁ to Yₙₖ These n groups correspond to X row electrode drivers 3₁ to 3ₙ and Y row electrode drivers 4₁ to 4ₙ, respectively.

A address driver 2 converts pixel data of each pixel based on a video signal to a pixel data pulse having a voltage value corresponding to a logic level of the pixel data and applies the voltage to each of the column electrodes D₁ to Dₘ for each row.

The X row electrode drivers 3₁ to 3ₙ, respectively, have sustaining, drivers 5₁ to 5ₙ and output drivers 6₁ to 6ₙ. There is a line XL commonly connecting between sustaining drivers 5₁ to 5ₙ and output drivers 6₁ to 6ₙ. Each of the sustaining drivers 5₁ to 5ₙ generates, as a drive pulse, a reset pulse for initializing residual wall charge of each discharge cell and a sustaining discharge pulse for sustaining a discharge luminescence state of a luminescent discharge cell as described later, and applies these pulses to the row electrodes X₁ to Xₙₖ via the corresponding output driver 6₁ to 6ₙ.

The Y row electrode drivers 4₁ to 4ₙ, respectively, have sustaining drivers 7₁ to 7ₙ and scan drivers 8₁ to 8ₙ. There is a line YL commonly connecting between the sustaining drivers 7₁ to 7ₙ and the scan drivers 8₁ to 8ₙ. Each of the sustaining drivers 7₁ to 7ₙ, in a manner similar to the sustaining drivers 5₁ to 5ₙ of the X row electrode drivers 3₁ to 3ₙ, generates a reset pulse for initializing residual wall charge of each discharge cell and a sustaining discharge pulse for sustaining a discharge luminescence state of each luminescent discharge cell, and applies these pulses on each of the row electrodes Y₁ to Yₙₖ via the corresponding scan driver 8₁ to 8ₙ. Each of the scan drivers 8₁ to 8ₙ generates a scan pulse SP for setting a luminescent discharge cell or non-luminescent discharge cell by obtaining the charge corresponding to the pixel data pulse for each discharge cell, and applies the pulse to the row electrodes Y₁ to Yₙₖ.

The connecting lines XL and YL are provided to unify the voltage levels of the drive pulses for the drivers 3₁ to 3ₙ, 4₁ to 4ₙ, respectively.

A control circuit 9 controls generation timing of the drive pulses of sustaining drivers 5₁ to 5ₙ, output drivers 6₁ to 6ₙ, the sustaining drivers 7₁ to 7ₙ, and the scan drivers 8₁ to 8ₙ.

FIG. 2 shows the configurations of the sustaining driver 7₁ and the scan driver 8₁. The sustaining driver 7₁ has power supplies B1, B2, a capacitor C, coils L1 to L2, a resistor R1, diodes D1, D2, and switching elements S1 to S6. The power supply B1 outputs a voltage V_{R}. The power supply B2 outputs a voltage V_{S}. The negative terminal of the power supply B1 is grounded, and the positive terminal is connected to the above-mentioned connecting line YL via the switching element S6 and the resistor R1.

The connecting line YL is grounded via the switching element S5 and the switching element S4. The voltage V_{S} from the positive terminal of the power supply B2 is applied via the switching element S3 to a connecting line CL between the switching element S5 and the switching element S4. Between the connecting line CL and the ground, the switching element S1, the diode D1, the coil L1, and the capacitor C are connected in series sequentially from the connecting line CL side. The polarity of the diode D1 is such that the anode is the coil L1 side and the cathode is the switching element S1 side. The series circuit including the coil L2, diode D2, and switching element S2 is connected in parallel to the series portion including the switching element S1, diode D1, and coil L1. One end of the coil L2 is connected to the connecting line CL, and one end of the switching element S2 is connected to the capacitor C. The polarity of the diode D2 is such that the anode is the coil L2 side and the cathode is the switching element S2 side.

The scan driver 8₁ has a power supply B3, switching elements S7₁ to S7ₖ, S8₁ to S8ₖ, and diodes D7₁ to D7ₖ, D8₁ to D8_{k.} The power supply B3 outputs a voltage Vₕ. The positive terminal of the power supply B3 is connected to the connecting line YL, and the negative terminal is connected to a negative-side connecting line NL within the scan driver 8₁. Between the connecting line YL and the negative-side connecting line NL, the switching elements S7₁ and S8₁ are connected in series, and the diodes D7₁ and D8₁ are also connected in series. The polarities of the diodes D7₁ and D8₁ are such that the cathode of the diode D7₁ is the connecting line YL side, the anode of the diode D7₁ and the cathode of the diode D8₁ are connected with each other, and the anode of diode D8₁ is the connecting line NL side. In addition, the connection point between the switching elements S7₁ and S8₁ and the connection point between the diodes D7₁ and D8₁ are connected with each other, and the connecting line between these connection points is connected to the row electrode Y₁. Also, the switching elements S7₂, S8₂, diodes D7₂, D8₂, and row electrode Y₂, . . . , the switching elements S7ₖ, S8ₖ, diodes D7ₖ, D8ₖ, and row electrode Yₖ are each connected in the same way as the switching elements S7₁, S8₁, diodes D7₁, D8₁, and row electrode Y₁.

The switching elements S1 to S6, S7₁ to S7ₖ, and S8₁ to S8ₖ are respectively switched in response to control signals supplied from a control circuit 9.

The sustaining drivers 7₂ to 7ₙ and the sustaining drivers 5₁ to 5ₙ of the X row electrode drivers 3₁ to 3ₙ are also provided with the same configuration as the sustaining driver 7₁. However, for the sustaining drivers 5₁ to 5ₙ of the X row electrode drivers 3₁ to 3ₙ, the power supply B1 is connected with the reverse polarity of that for the sustaining drivers 7₁ to 7ₙ. In addition, the scan drivers 8₂ to 8ₙ and the output drivers 6₁ to 6ₙ of the X row electrode drivers 3₁ to 3ₙ are also provided with the same configuration as the scan driver 8₁.

An operation of the PDP drive apparatus having the configuration as mentioned above, and more particularly, of the sustaining driver 7₁ and scan driver 8₁, will be explained next with reference to a timing chart in FIG. 3. The operation of the PDP drive apparatus has a reset period, an address period, and a sustaining period.

First, when a reset period starts, the sustaining drivers 5₁ to 5ₙ of the X row electrode drivers 3₁ to 3ₙ and the sustaining drivers 7₁ to 7ₙ of the Y row electrode drivers 4₁ to 4ₙ each generate reset pulses. The reset pulses are applied simultaneously to the row electrodes X₁ to Xₙₖ and row electrodes Y₁ to Yₙₖ. FIG. 3 shows a negative reset pulse that is applied to the row electrode X₁ and a positive reset pulse that is applied to the row electrode Y₁.

In the sustaining driver 7₁ and the scan driver 8₁, the operation during the reset period is as follows. In the sustaining driver 7₁, the switching element S6 is turned on, and the switching elements S1 to S5 are turned off. In the scan driver 8₁, the switching elements S7₁ to S7ₖ are turned on, and the switching elements S8₁ to S8ₖ are turned off. As a result, a current flows from the positive terminal of the power supply B1 to the row electrodes Y₁ to Yₖ via the resistor R1, connecting line YL, and switching elements S7₁ to S7ₖ, voltages that are applied to the row electrodes Y₁ to Yₖ gradually increase due to the capacitance components between the row electrodes X₁ to Xₖ and Y₁ to Yₖ, and positive reset pulses are formed as shown in FIG. 3. The voltage of these reset pulses finally increases to a voltage V_{R}. At this time, the switching elements S4 and S5 are turned on and the switching element S6 are turned off. Thus, since the connecting line YL is grounded, the reset pulses disappear.

As a result of the simultaneous applications of these reset pulses to the row electrodes X₁ to Xₙₖ and row electrodes Y₁ to Yₙₖ, all the discharge cells of the PDP 1 really discharge, and charged particles are generated. After the discharge ends, wall charges of predetermined amounts are uniformly formed on dielectric layers of all the discharge cells.

After the reset pulses have disappeared, an address period starts. During the address period, the address driver 2 converts pixel data for each pixel based on a video signal to pixel data pulses DP₁ to DPₘ having voltage values corresponding to logic levels of the pixel data, and applies these voltages sequentially to the column electrodes D₁ to Dₘ for each row. The pixel data pulses DP₁ to DPₘ are applied for the row electrode Y₁ as shown in FIG. 3. A scan pulse is repeatedly applied to the row electrodes Y₁ to Yₙₖ in that order by the scan drivers 8₁ to 8ₙ in synchronism with the individual application timing of the pixel data pulses DP₁ to DPₘ.

In the scan driver 8₁, the operation during the address period will be explained as follows. First, the switching element S7₁ is turned off and the switching element S8₁ is turned on at the same time. As a result, a voltage −Vₕ by the power supply B3 is added to the row electrode Y₁, as shown in FIG. 3, to become a scan pulse. The ground potential of 0V is applied to the row electrode X₁ as shown in FIG. 3. After the switching element S7₁ has been turned on and the switching element S8₁ has been turned off at the same time, the switching element S7₂ is turned off and the switching element S8₂ is turned on at the same time, and then the scan pulse is added to the row electrode Y₂. In this manner, the scan pulse is applied sequentially to the row electrodes Y₁ to Yₖ.

Of discharge cells belonging to a row electrode to which a scan pulse is applied, discharges will occur at discharge cells to which positive voltage pixel data pulses are respectively applied at the same time, and most of the wall charge as mentioned above is lost for each of the discharged cells. Since no discharge occurs at the remaining discharge cells to which a scan pulse is applied but no positive voltage pixel data pulse is applied, each wall charge remains. The discharge cells each of which has the wall charge are luminous discharge cells, and the discharged cells each of which has no wall charge are non-luminous discharge cells.

When a sustaining period starts after the address period, the X row electrode drivers 3₁ to 3ₙ apply a positive voltage sustaining pulse IP_{X} to the electrodes X₁ to Xₙₖ, and when sustaining pulse IP_{X} is eliminated, the Y row electrode drivers 4₁ to 4ₙ apply a sustaining pulse IP_{Y} to the electrodes Y₁ to Yₙₖ. The application of the sustaining pulse IP_{X} to the electrodes X₁ to Xₙₖ alternates with the application of the sustaining pulse IP_{Y} to the electrodes Y₁ to Yₙₖ. Since luminous discharge cells each of which has the wall charge remained repeatedly emit, these cells maintain a luminous state.

In the sustaining driver 7₁, the switching element S1 is turned on and the switching element S4 is turned off during the sustain period. The potential of the electrode Y₁ is substantially equal to the ground potential of 0V when the switching element S4 is turned on. However, when the switching element S4 is turned off and the switching element S1 is turned on, a current flows to the row element Y₁ via the coil L1, diode D1, switching element S1, switching element S5, connecting line YL, and switching element S7₁ due to a charge stored in the capacitor C, and charges the capacitance component between the row electrodes Y₁ and X₁. At this time, the potential of the electrode Y₁ increases gradually as shown in FIG. 3 due to the time constant of the coil L2 and capacitance component.

Subsequently, the switching element S1 is turned off and the switching element S3 is turned on. As a result, the voltage V_{S} by the power supply B2 is applied to the row electrode Y₁ via the switching element S3, switching element S5, connecting line YL, and switching element S7₁. After that, the switching element S3 is turned off and the switching element S2 is turned on, and a current flows into the capacitor C via the diode D7₁, connecting line YL, switching element S5, coil L2, diode D2, and switching element S2 from the electrode Y₁ due to the charge stored in the capacitance component between the row electrodes Y₁ and X₁. At this time, the potential of the electrode Y₁ decreases gradually as shown in FIG. 3 due to the time constant of the coil L2 and capacitor C. When the potential of the row electrode Y₁ is substantially equal to 0V, the switching element S2 is turned off and the switching element S4 is turned on. The row electrode Y₁ is supplied with the sustaining pulse IP_{Y} of a positive voltage as shown in FIG. 3, according to the operation.

The row electrodes X₁ to Xₙₖ and row electrodes Y₁ to Yₙₖ are each divided into n groups having k rows per group, and the X row electrode driver and Y row electrode driver are provided for each row electrode group as described above. The configuration is done to reduce a load for a single driver and distribute the overall generation of heat to each driver.

However, since the switching elements such as FETs, which respond to control signals, have different response speeds from each other in each of the X row electrode drivers and Y row electrode drivers, there are temporal errors in the generation of drive pulses in the row electrode drivers. The temporal errors in the generation of drive pulses cause the following problem. A load is applied to a row electrode driver at which a drive pulse is early generated due to the existence of the connecting line between the row electrode drivers, and the value of an electric current supplied to the row electrode from that row electrode driver increases. Thus, the loaded row electrode driver generates heat. For example, if some delay interval elapses after the Y row electrode driver 4₁ starts outputting a sustaining pulse as shown in FIG. 4A before the Y row electrode driver 4₂ outputs a sustaining pulse as shown in FIG. 4B, the output current by the drive pulse of the Y row electrode driver 4₁ shown in FIG. 4C becomes larger than the output current by the drive pulse of the Y row electrode driver 4₂ shown in FIG. 4D, and the amount of heat generated by the Y row electrode driver 4₁ increases.

### SUMMARY OF THE INVENTION

An object of the present invention is to provide a drive apparatus for a display panel that can make power consumption of a row electrode drive circuit of each row electrode group substantially uniform to prevent an increase in the amount of heat generated therein.

According to the present invention, there is provided a drive apparatus for driving a display panel having a plurality of row electrode groups each including a plurality of row electrodes, and a plurality of column electrodes arrayed in the direction intersecting with each row electrode of the plurality of row electrode groups so as to form display cells at the intersection points; the drive apparatus further comprising: a controller for generating a control signal for each of the row electrode groups; a row electrode drive circuit provided for each of the row electrode groups, for generating a drive pulse in response to the control signal and supplying the drive pulse to each row electrode of the corresponding row electrode group; and an adjusting device for delaying the control signal which is supplied to the drive circuit for each of the row electrode groups.

### BRIEF DESCRIPTION OF THE DRAWINGS

FIG. 1 is a block diagram showing a conventional PDP drive apparatus;

FIG. 2 is a circuit diagram showing the configuration of a conventional drive apparatus;

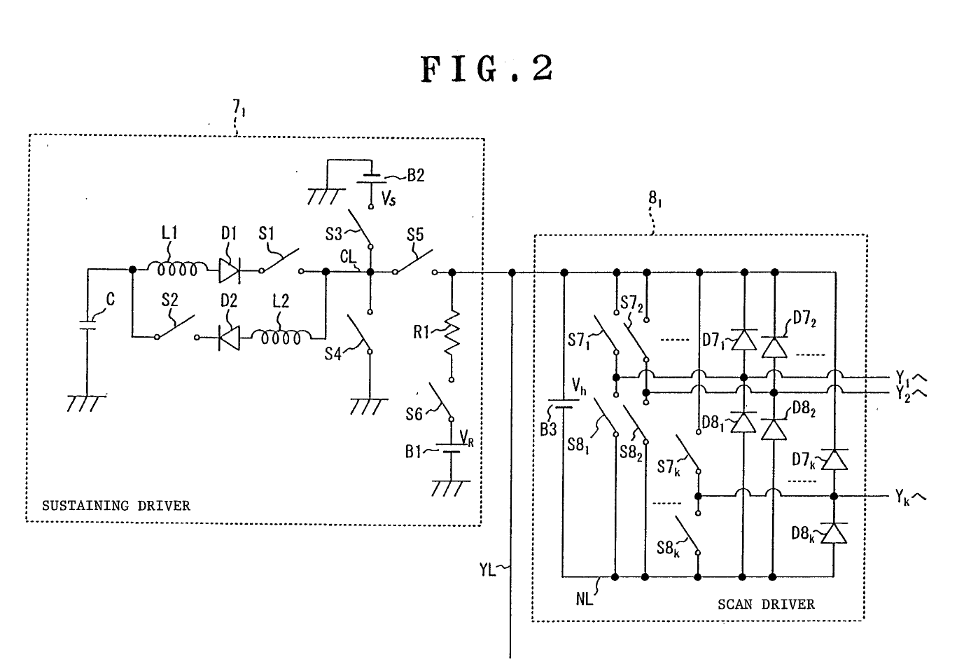

FIG. 3 is a timing chart of each part of the apparatus in FIG. 2;

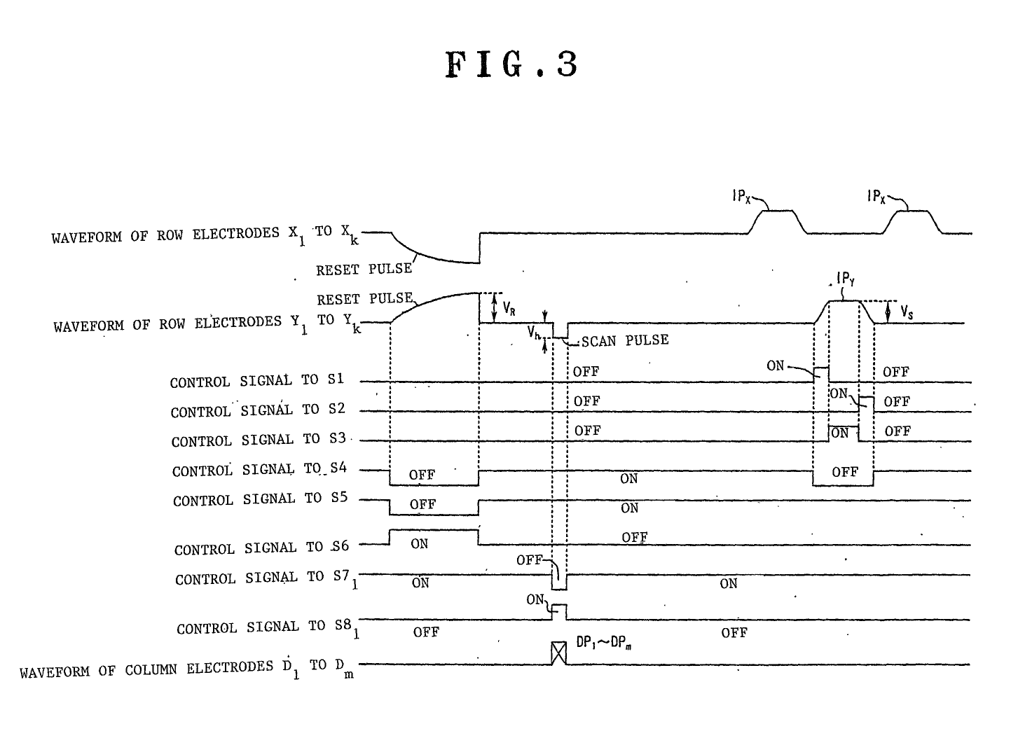

FIGS. 4A to 4D show timing of sustaining pulses and drive current waveforms;

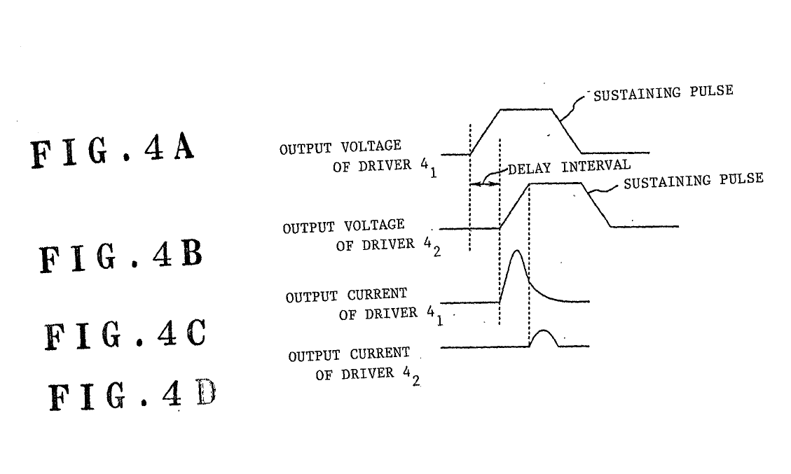

FIG. 5 is a block diagram showing an embodiment of the present invention;

FIG. 6 is a block diagram showing another embodiment of the present invention;

FIG. 7 is a block diagram showing another embodiment of the present invention; and

FIG. 8 is a block diagram showing still another embodiment of the present invention.

### DESCRIPTION OF THE PREFERRED EMBODIMENTS

Embodiments of the present invention will be described in detail below with reference to the figures.

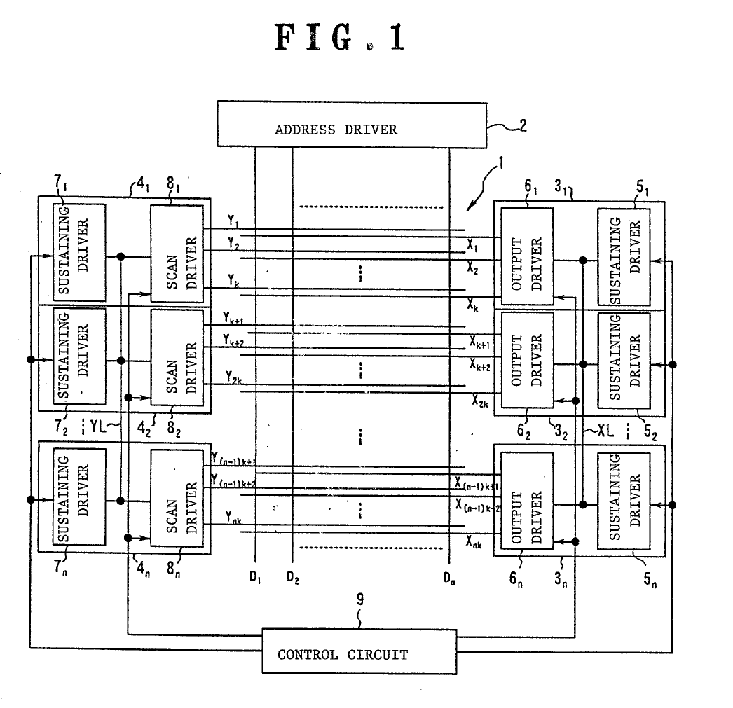

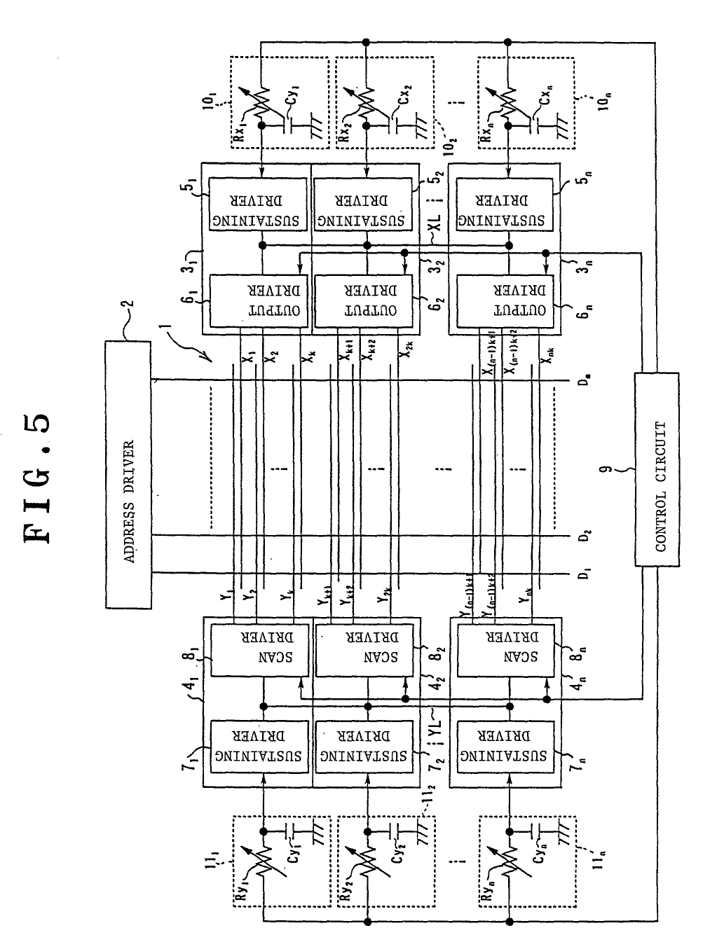

FIG. 5 shows the configuration of a PDP drive apparatus according to the present invention. In FIG. 5, the same symbols are used for the same parts as those used in the conventional apparatus shown in FIG. 1. In the PDP drive apparatus of FIG. 5, delay circuits 10₁ to 10ₙ are respectively inserted between the control circuit 9 and the sustaining drivers 5₁ to 5ₙ of the X row electrode drivers 3₁ to 3ₙ, respectively, and delay circuits 11₁ to 11ₙ are similarly inserted between the control circuit 9 and the sustaining drivers 7₁ to 7ₙ of the Y row electrode drivers 4₁ to 4ₙ, respectively. That is, control signals for switching the switching elements of the sustaining drivers 5₁ to 5ₙ are respectively supplied from the control circuit 9 to the sustaining drivers 5₁ to 5ₙ via the delay circuits 10₁ to 10ₙ. Also, control signals for switching the switching elements of the sustaining drivers 7₁ to 7ₙ are respectively supplied from the control circuit 9 to the sustaining drivers 7₁ to 7ₙ via the delay circuits 11₁ to 11ₙ.

The delay circuits 10₁ to 10ₙ and delay circuits 11₁ to 11ₙ are formed by integrating circuits having resistors Rx₁ to Rxₙ, Ry₁ to Ryₙ and capacitors Cx₁ to Cxₙ, Cy₁ to Cyₙ, respectively, as shown in FIG. 5. The resistors Rx₁ to Rxₙ and Ry₁ to Ryₙ are variable resistors, which can change the delay times of the delay circuits 10₁ to 10ₙ and delay circuits 11₁ to 11ₙ, respectively, in accordance with manual operation.

By setting longer the delay times of the delay circuits connected to sustaining drivers having faster responses to control signals from the control circuit 9, the respective sustaining drivers (switching elements S1 to S6) can be activated at the same timing. Therefore, drive pulses (reset pulse pulses and sustaining pulses) can be generated at the same timing. As a result, the values of electric currents supplied to the row electrodes X₁ to Xₙₖ from the output drivers 6₁ to 6ₙ of the X row electrode drivers 3₁ to 3ₙ, respectively, become substantially uniform, and similarly, the values of electric currents supplied to the row electrodes Y₁ to Yₙₖ from the scan drivers 8₁ to 8ₙ of Y row electrode drivers 4₁ to 4ₙ, respectively, become substantially uniform. Heat generated in respective elements such as switching elements is distributed to each of the row electrode drivers 3₁ to 3ₙ, 4₁ to 4ₙ.

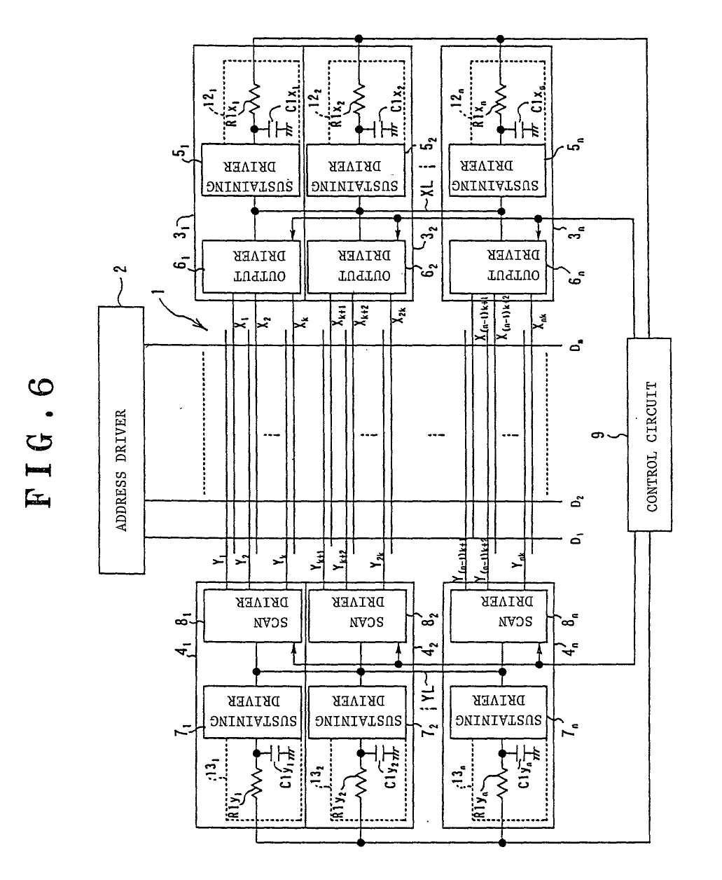

FIG. 6 shows the configuration of a PDP drive apparatus of another embodiment of the present invention. In FIG. 6, the same symbols are used for the same parts as those used in the conventional apparatus shown in FIG. 1. The PDP drive apparatus of FIG. 6 has delay circuits 12₁ to 12ₙ, 13₁ to 13ₙ in a similar manner as those in the apparatus of FIG. 5. In the drive apparatus of FIG. 6, the sustaining drivers 5₁ to 5ₙ are modularized in a configuration including the delay circuits 12₁ to 12ₙ, respectively. Similarly, the sustaining drivers 7₁ to 7ₙ are modularized in a configuration including the delay circuits 13₁ to 13ₙ, respectively.

The delay circuits 12₁ to 12ₙ, 13₁ to 13ₙ are formed by integrating circuits including resistors R1x₁ to R1xₙ, R1y₁ to R1yₙ and capacitors C1x₁ to C1xₙ, C1y₁ to C1yₙ, respectively, as shown in FIG. 6. The resistors R1x₁ to R1xₙ, R1y₁ to R1yₙ and capacitors C1x₁ to C1xₙ, C1y₁ to C1yₙ, have positive temperature characteristics.

In the configuration shown in FIG. 6, if the value of a current supplied to any of the row electrodes X₁ to Xₙₖ, Y₁ to Yₙₖ is large and the amount of heat generated by the corresponding sustaining driver increases, the resistance value, for example, of the delay circuit within that sustaining driver increases for generating heat, and the delay time of the delay circuit becomes longer. The respective sustaining drivers (switching elements S1 to S6) can be activated at the same timing. Therefore, drive pulses (reset pulse pulses and sustaining pulses) can be generated at the same timing. As a result, the values of electric currents supplied to the row electrodes X₁ to Xₙₖ from the output drivers 6₁ to 6ₙ of the X row electrode drivers 3₁ to 3ₙ, respectively, become substantially uniform, and similarly, the values of electric currents supplied to the row electrodes Y₁ to Yₙₖ from the scan drivers 8₁ to 8ₙ of Y row electrode drivers 4₁ to 4ₙ, respectively, become substantially uniform. Heat generated in respective elements such as switching elements is distributed to each of the row electrode drivers 3₁ to 3ₙ, 4₁ to 4ₙ.

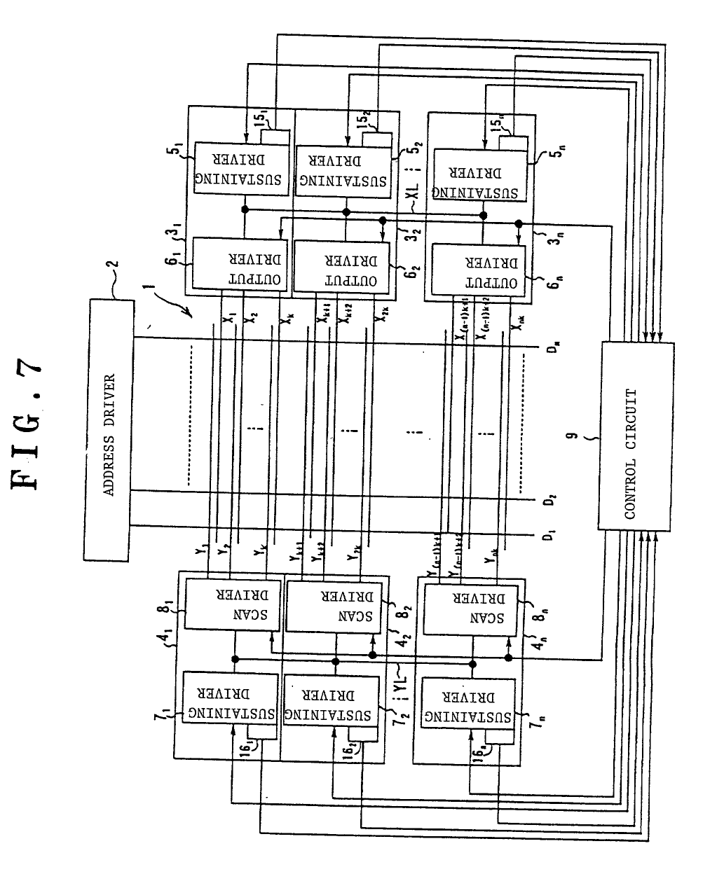

FIG. 7 shows the configuration of a PDP drive apparatus of another embodiment of the present invention. In FIG. 7, the same symbols are used for the same parts as those used in the conventional apparatus shown in FIG. 1. The PDP drive apparatus of FIG. 7 has temperature sensors 15₁ to 15ₙ which are attached to the sustaining drivers 5₁ to 5ₙ of the X row electrode drivers 3₁ to 3ₙ, respectively. The temperature sensors 15₁ to 15ₙ detect the temperatures of the sustaining drivers 5₁ to 5ₙ and supply signals indicating the detected temperatures to the control circuit 9. The PDP drive apparatus of FIG. 7 also has temperature sensors temperature sensors 16₁ to 16ₙ which are attached to the sustaining drivers 7₁ to 7ₙ of the Y row electrode drivers 4₁ to 4ₙ, respectively. The temperature sensors 16₁ to 16ₙ detect the temperatures of the sustaining drivers 7₁ to 7ₙ and supply signals indicating the detected temperatures to the control circuit 9.

The control circuit 9 monitors the detected temperatures indicated by the signals supplied from the temperature sensors 15₁ to 15ₙ, 16₁ to 16ₙ, respectively, and delays the supply timing of a control signal to the corresponding sustaining driver when a increase in any of the detected temperatures is detected, or advances the supply timing of the control signal to the corresponding sustaining driver when a decrease in any of the detected temperature is detected.

By the timing control operation based on the detected temperatures, the respective sustaining drivers (switching elements S1 to S6) can be activated at the same timing. Therefore, drive pulses (reset pulse pulses and sustaining pulses) can be generated at the same timing. As a result, the values of electric currents supplied to the row electrodes X₁ to Xₙₖ from the output drivers 6₁ to 6ₙ of the X row electrode drivers 3₁ to 3ₙ, respectively, become substantially uniform, and similarly, the values of electric currents supplied to the row electrodes Y₁ to Yₙₖ from the scan drivers 8₁ to 8ₙ of Y row electrode drivers 4₁ to 4ₙ, respectively, become substantially uniform. Heat generated in respective elements such as switching elements is distributed to each of the row electrode drivers 3₁ to 3ₙ, 4₁ to 4ₙ.

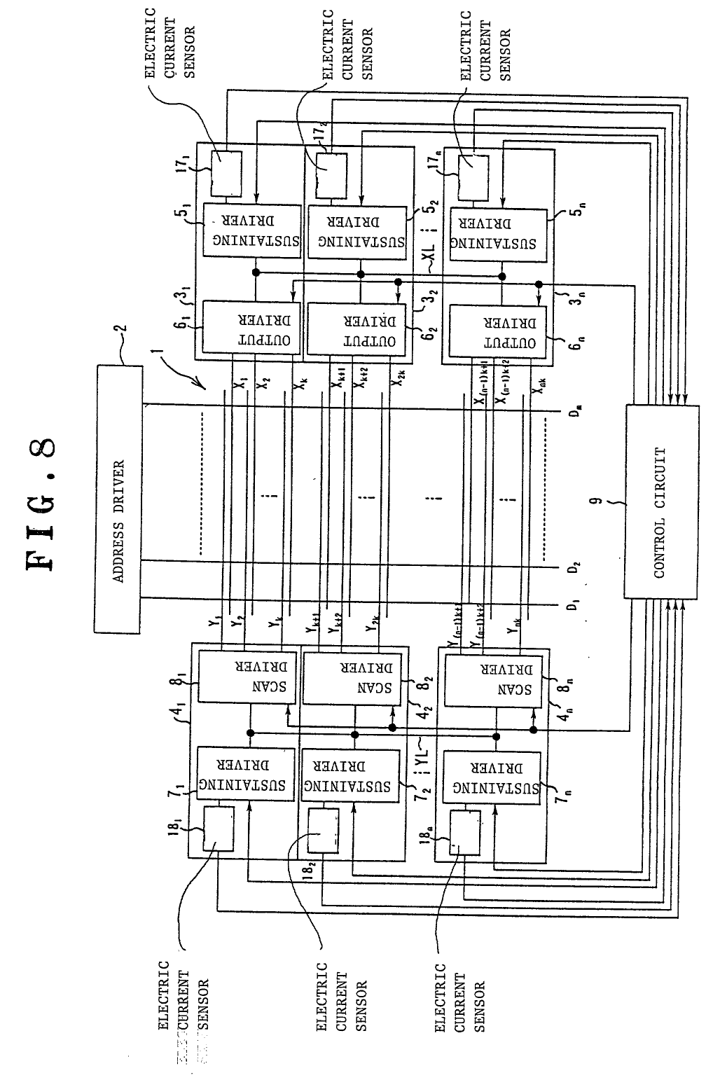

FIG. 8 shows the configuration of a PDP drive apparatus of another embodiment of the present invention. In FIG. 8, the same symbols are used for the same parts as those used in the conventional apparatus shown in FIG. 1. The PDP drive apparatus of FIG. 8 has electric current sensors 17₁ to 17ₙ for each detecting the value of the current output from the positive terminal of the power source B2 in each of the sustaining drivers 5₁ to 5ₙ of the X row electrode drivers 3₁ to 3ₙ. The PDP drive apparatus of FIG. 8 also has electric current sensors 18₁ to 18ₙ for each detecting the value of the current output from the positive terminal of the power source B2 in each of the sustaining drivers 7₁ to 7ₙ of the Y row electrode drivers 4₁ to 4ₙ. The detected outputs of the electric current sensors 17₁ to 17ₙ, 18₁ to 18ₙ are supplied to the control circuit 9.

The control circuit 9 monitors the detected current values indicated by the signals supplied from the electric current sensors 17₁ to 17ₙ, 18₁ to 18ₙ, respectively, and delays the supply timing of the control signal to the corresponding sustaining driver if a increase in any of the detected current values is detected, or advances the supply timing of the control signal to the corresponding sustaining driver if a decrease in any of the detected current values is detected.

By the timing control operation based on the detected current values, the respective sustaining drivers (switching elements S1 to S6) can be activated at the same timing. Therefore, drive pulses (reset pulse pulses and sustaining pulses) can be generated at the same timing. As a result, the values of electric currents supplied to the row electrodes X₁ to Xₙₖ from the output drivers 6₁ to 6ₙ of the X row electrode drivers 3₁ to 3ₙ, respectively, become substantially uniform, and similarly, the values of electric currents supplied to the row electrodes Y₁ to Yₙₖ from the scan drivers 8₁ to 8ₙ of Y row electrode drivers 4₁ to 4ₙ, respectively, become substantially uniform. Heat generated in respective elements such as switching elements is distributed to each of the row electrode drivers 3₁ to 3ₙ, 4₁ to 4ₙ.

When the PDP 1 is installed so that the display surface is vertical, the temperature of the upper part of the PDP 1 increases more than that of the lower part. Even if the values of the electric current output to the row electrodes from each of the row electrode drivers are substantially equal to each other as described above, the sustaining pulses can be output earlier, by intentionally adjusting the timing of the control signals in consideration of the increase the temperature in the upper part of the PDP 1, or by advancing the timing of control signals supplied to some sustaining drivers located in the lower part of the PDP 1. As a result, when the temperature of the upper part of the PDP 1 increases more than that of the lower part, heat generated by the row electrode drivers can be uniformed by increasing the values of the electric currents output to the row electrodes from the row electrode drivers of the lower part of the PDP 1.

Since the present invention can make the electric power consumption of the row electrode drive circuit of each row electrode group substantially uniform as described above, an increase in the amount of heat generated by each row electrode circuit can be prevented.

This application is based on a Japanese Patent Application No. 2001-137207 which is hereby incorporated by reference.

What is claimed is:

1. A drive apparatus for driving a display panel having a plurality of row electrode groups each including a plurality of row electrodes, and a plurality of column electrodes arrayed in the direction intersecting with each row electrode of said plurality of row electrode groups so as to form display cells at the intersection points; said drive apparatus further comprising:
a controller for generating a control signal for each of said row electrode groups;
a row electrode drive circuit provided for each of said row electrode groups, for generating a drive pulse in response to said control signal and supplying the drive pulse to each row electrode of the corresponding row electrode group; and
an adjusting device for delaying the control signal which is supplied to said drive circuit for each of said row electrode groups.

2. A drive apparatus according to claim 1, wherein said display panel is a plasma display panel, and said row electrode drive circuit generates a sustaining pulse as the drive pulse.

3. The display panel drive apparatus according to claim 1, wherein said adjusting device is a delay circuit including a variable resistor and a capacitor provided for each of said row electrode groups.

4. A drive apparatus according to claim 1, wherein said adjusting device is a delay circuit including an element having a positive temperature characteristic, which is provided for each of said row electrode groups, and said delay circuit is located in the vicinity of said row electrode drive circuit.

5. A drive apparatus according to claim 1, wherein said adjusting device has, for each of said row electrode groups, a temperature sensor for detecting the temperature of said drive circuit, and an adjusting circuit for adjusting the delay time for supplying the control signal to said drive circuit in,accordance with the temperature detected by said temperature sensor.

6. A drive apparatus according to claim 5, wherein said adjusting circuit lengthens the delay time for supplying said control signal to said drive circuit as the temperature detected by said temperature sensor is higher.

7. A drive apparatus according to claim 1, wherein said adjusting device has, for each of said row electrode groups, an electric current sensor for detecting the value of a current output from a power source for said drive circuit, and a adjusting circuit for adjusting the delay time for supplying the control signal to said drive circuit in accordance with the value of the current detected by said electric current sensor.

8. A drive apparatus according to claim 7, wherein said adjusting circuit lengthens the delay time for supplying said control signal to said drive circuit as the value of the current detected by said electric current sensor is higher.
